(19) United States
(12) Patent Application Publication
(10) Pub. No.: US 2026/0056140 A1
(43) Pub. Date: Feb. 26, 2026

(54) RADIOGRAPHIC IMAGING SYSTEM AND CONTROL APPARATUS

(71) Applicant: KONICA MINOLTA, INC., Tokyo (JP)

(72) Inventor: Mao EGUCHI, Tokyo (JP)

(73) Assignee: KONICA MINOLTA, INC., Tokyo (JP)

(21) Appl. No.: 19/300,206

(22) Filed: Aug. 14, 2025

(30) Foreign Application Priority Data
Aug. 22, 2024 (JP) 2024-140803

(51) Int. Cl. G01N 23/04

(52) U.S. Cl. CPC G01N 23/04; G01N 2223/304; G01N 2223/306; G01N 2223/408

(57) ABSTRACT

Disclosed is a radiographic imaging system including: a first radiographic imaging apparatus and a second radiographic imaging apparatus capable of generating moving image data; a radiation irradiation apparatus that irradiates the first radiographic imaging apparatus or the second radiographic imaging apparatus with radiation; and a control apparatus that executes synchronization processing of synchronizing a timing of radiographic imaging by the first radiographic imaging apparatus or the second radiographic imaging apparatus with a timing of radiation irradiation by the radiation irradiation apparatus. The control apparatus includes a hardware processor that controls, based on a state of the synchronizing of the first radiographic imaging apparatus, radiographic imaging by the second radiographic imaging apparatus for which the synchronization processing has been performed earlier than the first radiographic imaging apparatus.

### CROSS-REFERENCE TO RELATED APPLICATION

The entire disclosure of Japanese Patent Application No.2024 -140803, filed on August 22, 2024, including description, claims, drawings and abstract is incorporated herein by reference.

### BACKGROUND OF THE INVENTION

### TECHNICAL FIELD

The present disclosure relates to a radiographic imaging system and a control apparatus.

### DESCRIPTION OF RELATED ART

Description of the Related Art In the related art, a radiographic imaging system that performs dynamic imaging for obtaining a plurality of frame images by continuously imaging a subject at a predetermined interval is known. In order to prevent generation of an abnormal image when the dynamic imaging is performed in the radiographic imaging system, synchronization processing for synchronizing signals indicating timings of the emission of the radiations between the radiographic imaging apparatus and the radiation irradiation apparatus is performed in advance (for example, see the following Japanese Unexamined Patent Publication No. 2023-5 which is also referred to as JP2023000005 (A)).

However, in the radiographic imaging system disclosed in Japanese Unexamined Patent Publication No. 2023-5, when another radiographic imaging apparatus different from the one radiographic imaging apparatus on which the synchronization processing has been performed is connected to the radiation irradiation apparatus by wire, priority is given to the synchronization between the other radiographic imaging apparatus and the irradiation apparatus. Then, the synchronization between the one radiographic imaging apparatus and the radiation irradiation apparatus is released. For this reason, in the above-described radiographic imaging system, the number of radiographic imaging apparatuses in a state in which the dynamic imaging can be performed is limited, and thus there is a problem in that usability of the radiographic imaging apparatus is deteriorated.

### SUMMARY OF THE INVENTION

The present disclosure has been made in consideration of the above-described problem, and has as its object to improve the usability of a radiographic imaging apparatus.

To achieve at least one of the abovementioned objects, according to an aspect of the present disclosure, a radiographic imaging system reflecting one aspect of the present disclosure is a radiographic imaging system including: a first radiographic imaging apparatus and a second radiographic imaging apparatus capable of generating moving image data; a radiation irradiation apparatus that irradiates the first radiographic imaging apparatus or the second radiographic imaging apparatus with radiation; and a control apparatus that executes synchronization processing of synchronizing a timing of radiographic imaging by the first radiographic imaging apparatus or the second radiographic imaging apparatus with a timing of radiation irradiation by the radiation irradiation apparatus, wherein the control apparatus includes a hardware processor that controls, based on a state of the synchronizing of the first radiographic imaging apparatus, radiographic imaging by the second radiographic imaging apparatus for which the synchronization processing has been performed earlier than the first radiographic imaging apparatus.

### BRIEF DESCRIPTION OF THE DRAWINGS

The advantages and features provided by one or more embodiments of the invention will become more fully understood from the detailed description given hereinafter and the appended drawings which are given by way of illustration only, and thus are not intended as a definition of the limits of the present disclosure, and wherein:

FIG. 1 is a block diagram illustrating a schematic configuration of a radiographic imaging system;

FIG. 2 is a block diagram illustrating a functional configuration of a console;

FIG. 3 is a block diagram illustrating a functional configuration of a radiation control apparatus;

FIG. 4 is a block diagram illustrating a functional configuration of the radiographic imaging apparatus;

FIG. 5 is a block diagram illustrating a schematic configuration of the medical cart;

FIG. 6 is a block diagram illustrating a functional configuration of a console;

FIG. 7 is a block diagram illustrating a functional configuration of a radiation control apparatus;

FIG. 8 is a flowchart illustrating synchronization determination processing in the radiographic imaging system;

FIG. 9 is a flowchart illustrating synchronization determination processing in the radiographic imaging system;

FIG. 10 is a flowchart illustrating synchronization determination processing in the radiographic imaging system;

FIG. 11 is a flowchart illustrating synchronization processing in the radiographic imaging system;

FIG. 12 is a flowchart illustrating synchronization release processing in the radiographic imaging system;

FIG. 13 is a diagram illustrating an example of a display form on the display part of the radiographic imaging apparatus;

FIG. 14 is a diagram illustrating an example of a display form on the display part of the radiographic imaging apparatus;

FIG. 15 is a diagram illustrating an example of a display form on the display part of the radiographic imaging apparatus;

FIG. 16 is a diagram illustrating an example of a display form on the display part of the radiographic imaging apparatus;

FIG. 17 is a diagram illustrating an example of a display screen when state information of each radiographic imaging apparatus before synchronization of the radiographic imaging apparatuses of the panel ID"P002" is completed is displayed on the display part; and

FIG. 18 is a view illustrating an example of a display screen when the state information of each radiographic imaging apparatus is displayed on the display part after the synchronization of the radiographic imaging apparatuses of the panel ID"P002" is completed.

### DETAILED DESCRIPTION

Hereinafter, embodiment of the present disclosure will be described with reference to the drawings. However, the technical scope of the present disclosure is not limited to the following embodiment and the examples illustrated in the drawings.

### 1. Configuration of Radiographic Imaging System

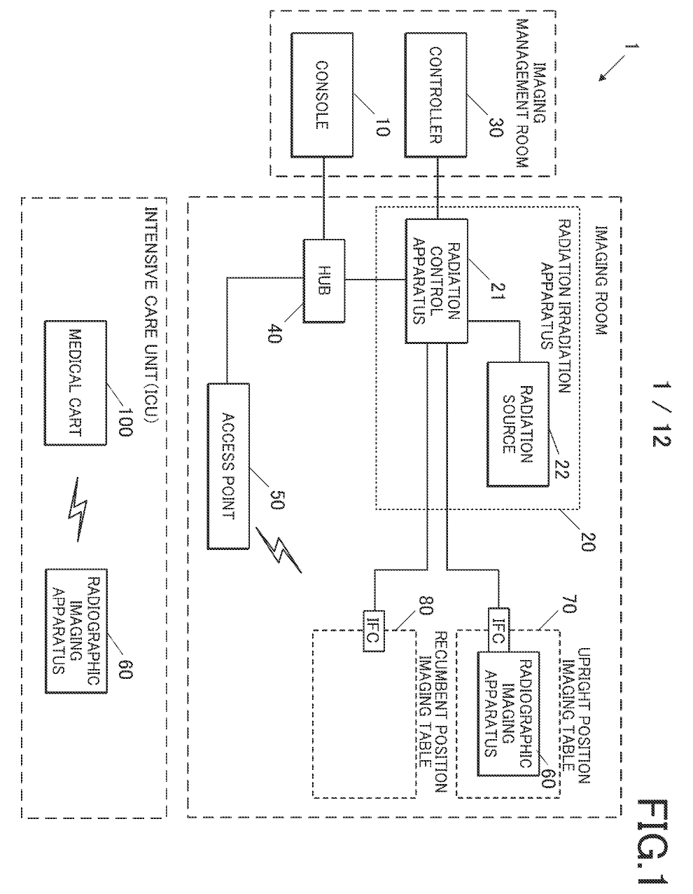

First, a schematic configuration of a radiographic imaging system according to the present embodiment will be described with reference to FIG. 1. FIG. 1 is a block diagram showing a schematic configuration of a radiographic imaging system 1.

As illustrated in FIG. 1, the radiographic imaging system (hereinafter, system) 1 includes a console 10, a radiation irradiation apparatus 20, a controller 30, a hub 40, an access point 50, a medical cart 100, and a plurality of radiographic imaging apparatuses 60.

As illustrated in FIG. 1, a radiation irradiation apparatus (hereinafter, irradiation apparatus) 20, a hub 40, and an access point 50 are provided in an imaging room in which radiographic imaging is performed. In the imaging room, for example, one upright position imaging table 70 and one recumbent position imaging table 80 are installed. In the example illustrated in FIG. 1, one radiographic imaging apparatus (hereinafter, imaging apparatus) 60 is provided on the upright position imaging table 70. The imaging apparatus 60 is wiredly connected to the radiation control apparatus 21 constituting the irradiation apparatus 20 via a communication cable (IFC). Note that the imaging apparatus 60 can perform wired imaging in which radiographic imaging is performed in a state of being connected to the radiation control apparatus 21 in a wired manner as described above on the upright position imaging table 70 or the recumbent position imaging table 80. The imaging apparatus 60 can perform wireless imaging for performing radiographic imaging in a state of being wirelessly connected to the radiation control apparatus 21 via the access point 50 on the upright position imaging table 70 or the recumbent position imaging table 80. The console 10 and the controller 30 are provided in an imaging management room adjacent to the imaging room. The medical cart 100 is provided in, for example, an intensive care unit (ICU), but includes wheels and the like (not illustrated) so as to be movable to another room.

### 1-1. Console

The console 10 can set imaging conditions (imaging mode (still image imaging, dynamic imaging), tube voltage, tube current and irradiation time or current-time product (mAs value), imaging area, imaging direction, and the like) in at least one of the radiation control apparatus 21 and the imaging apparatus 60 based on an imaging order acquired from another system such as a radiology information system (RIS) or a picture archiving and communication system (PACS), or an operation performed on the controller 30 by a user (for example, a radiologist). In addition, the console 10 can acquire image data of a radiographic image generated by the imaging apparatus 60, store the image data in the console 10, and transmit the image data to another apparatus (a PACS, a dynamic analysis apparatus, or the like).

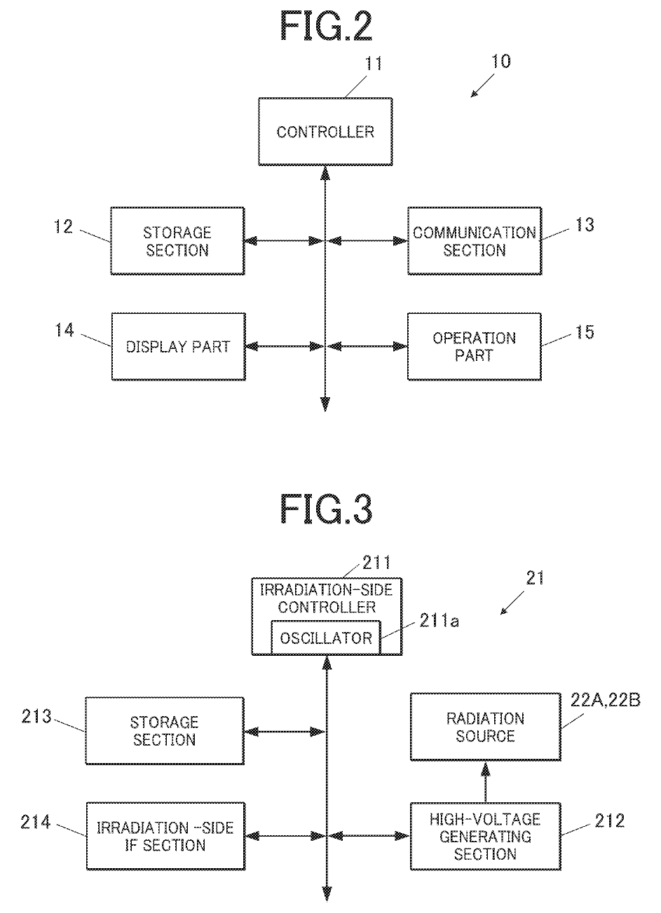

Next, the functional configuration of the console 10 will be described referring to FIG. 2.

FIG. 2 is a block diagram illustrating a functional configuration of the console 10.

As illustrated in FIG. 2, the console 10 includes a controller 11, a storage section 12, a communication section 13, a display part 14 (display), and an operation part 15. The components 11 to 15 of the console 10 are electrically connected to each other by a bus or the like.

The controller 11 is configured by a central processing unit (CPU), a random access memory (RAM), and the like, and performs centralized control of operation of sections of the console 10. The controller 11 also executes synchronization processing for synchronizing signals indicating timings of radiation irradiation between the imaging apparatus 60 and the irradiation apparatus 20. In other words, the controller 11 executes synchronization processing for synchronizing the timing of radiographic imaging by the imaging apparatus 60 and the timing of radiation irradiation by the irradiation apparatus 20. In addition, the controller 11 displays the synchronization state of the imaging apparatus 60 on the display part 14.

The storage section 12 includes a nonvolatile memory and a hard disk and stores various programs to be executed by the CPU, parameters necessary for executing the programs, and the like. The storage section 12 is capable of storing image data of a radiographic image acquired from another apparatus (the imaging apparatus 60 or the like). The storage section 12 also stores examination order information transmitted from the RIS or the like. In addition, the storage section 12 stores each set of the irradiation apparatus 20 and the imaging apparatus 60 in which the clocking information is synchronized and associated with each other by using an ID for identifying the set.

The communication section 13 includes a communication module and the like. The communication section 13 transmits and receives various signals and various data to and from other apparatuses (the irradiation apparatus 20, the imaging apparatus 60, and the like) connected in a wired or wireless manner via a communication network.

The display part 14 is configured by, for example, a liquid crystal display (LCD), a cathode ray tube (CRT), or the like. The display part 14 displays a radiographic image or the like corresponding to an image signal received from the controller 11.

The operation part 15 includes a keyboard (cursor keys, number input keys, various function keys, and the like), a pointing device (mouse and the like), a touch screen stacked on a surface of the display part 14, and the like. The operation part 15 outputs a control signal corresponding to an operation performed by the user to the controller 11.

### 1-2. radiation irradiation apparatus

The irradiation apparatus 20 generates radiation (for example, X-rays) and irradiates the subject and the imaging apparatus 60 disposed behind the subject with the radiation, and includes a radiation control apparatus (hereinafter, a control apparatus) 21 and a radiation source 22.

Next, a functional configuration of the control apparatus 21 included in the irradiation apparatus 20 will be described with reference to FIG. 3. FIG. 3 is a block diagram showing a functional configuration of the control apparatus 21.

As shown in FIG. 3, the control apparatus 21 includes an irradiation-side controller 211, a high voltage generating section 212, a storage section 213, an irradiation-side interface section (hereinafter referred to as an irradiation-side IF section) 214, and the like. The sections 211 to 214 of the control apparatus 21 can be supplied with electric power by a power cable or a built-in power source (not shown).

The irradiation-side controller 211 includes a CPU, a RAM, and the like, and is configured to comprehensively control the operation of the sections 212 to 214 of the control apparatus 21. the irradiation-side controller 211 includes an oscillator (hereinafter, irradiation-side oscillator) 211a. The irradiation side oscillator 211a can be configured by a crystal oscillator, a ceramic oscillator, or the like that generates a clock of a predetermined cycle when the power is turned on. The irradiation-side controller 211 periodically generates clocking information using the clock generated by the irradiation-side oscillator 211a and has the function to do so. The clocking information generated here includes, for example, a timing signal and time information. The timing signal refers to a pulsed signal or the like that is output every time one or a plurality of clocks are generated. The time information indicates a count value or the like for counting up the timing signal. In addition, the respective sections 211 to 214 of the control apparatus 21 are operated based on the clock generated by the irradiation side oscillator 211a. Further, as the irradiation side oscillator 211a, a plurality of oscillators may be selectively used according to a purpose such as required accuracy.

The high-voltage generating section 212 applies a voltage corresponding to a preset imaging condition to the radiation source 22 based on the reception of the timing signal from the irradiation-side controller 211. The imaging condition are, for example, conditions related to a subject such as an imaging mode (still image imaging or dynamic imaging), an imaging target site, and a physique, and conditions related to radiation irradiation such as a tube voltage, a tube current, an irradiation time, and a current-time product. The imaging mode included in the imaging condition is, for example, information on an imaging method such as still image capturing and dynamic imaging. In the system 1 of the present embodiment, a photographing mode can be set in advance, and the high voltage generating section 212 performs an operation suitable for the photographing mode in accordance with the setting of the photographing mode. Here, the dynamic imaging includes moving image capturing, but does not include capturing a still image while displaying a moving image. A series of images obtained by dynamic imaging is referred to as a dynamic image. The dynamic image includes a moving image, but does not include an image obtained by capturing a still image while displaying the moving image. When the imaging condition includes dynamic imaging, a pulsed voltage is repeatedly applied at predetermined intervals each time a timing signal is received. When a voltage is applied from the high-voltage generating section 212, the radiation source 22 generates a dose of radiation corresponding to the applied voltage. Specifically, when a pulsed voltage is applied from the high voltage generating section 212, pulsed radiation is emitted.

The storage section 213 includes a hard disk drive (HDD) and a semiconductor memory, and stores various processing programs and parameters and files necessary for executing the processing programs.

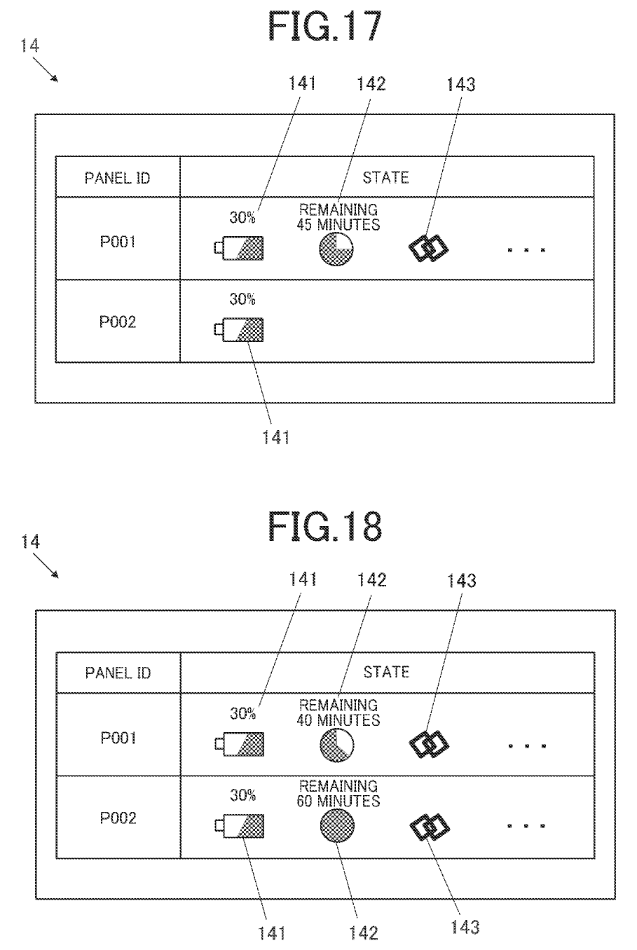

The storage section 213 can store various kinds of data (for example, clocking information and the like) generated in the course of processing performed by the irradiation-side controller 211. The storage section 213 stores an ID (panel ID; see FIGS. 16 and 17) for identifying the imaging apparatus 60 with which the clocking information is synchronized. The storage section 213 also stores synchronization time limit information. In the synchronization of the clocking information between the irradiation apparatus 20 and the imaging apparatus 60, synchronization accuracy decreases with the lapse of time due to an individual difference or a temperature characteristic difference between the irradiation-side oscillator 211a and an imaging-side oscillator 61a to be described later. Therefore, the synchronization time limit information is information on a synchronization time limit which is a synchronization maintainable time during which the synchronization of the clocking information can be maintained in a state in which the connection between the irradiation apparatus 20 and the imaging apparatus 60 via the communication cable (IFC) is released.

The irradiation-side IF section 214 is connectable to an external interface (IF) and is configured to be able to transmit and receive various kinds of information (signals and data). Specifically, it can be composed of a connector or the like for inserting a communication cable (IFC).

The irradiation-side controller 211 of the irradiation apparatus 20 configured as described above operates as follows in accordance with a program stored in the storage section 213. For example, the irradiation-side controller 211 sets various imaging conditions (conditions relating to the subject such as an imaging mode (still image imaging or dynamic imaging), an imaging target site, and a physique, and conditions relating to radiation irradiation such as a tube voltage, a tube current, an irradiation time, a current-time product, and a frame rate). Furthermore, based on reception of the exposure permission notification from the imaging apparatus 60, the irradiation-side controller 211 controls the high-voltage generating section 212 to start exposure (emission of radiation). If the imaging condition includes dynamic imaging, exposure is performed at a cycle corresponding to the frame rate.

### 1-3. radiographic imaging apparatus

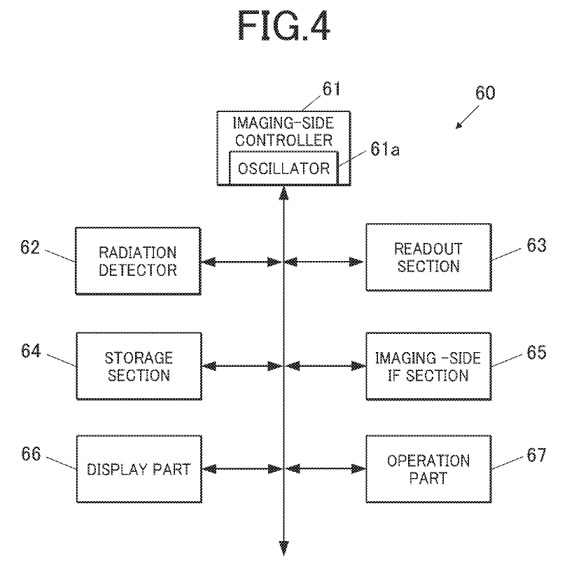

Next, a functional configuration of the imaging apparatus 60 will be described with reference to FIG. 4. FIG. 4 is a block diagram illustrating a functional configuration of the imaging apparatus 60.

As illustrated in FIG. 4, the imaging apparatus 60 includes an imaging-side controller 61, a radiation detector 62, a readout section 63, a storage section 64, an imaging side interface section (hereinafter, imaging side IF section) 65, and the like. The sections 61 to 65 of the imaging apparatus 60 can be supplied with power from a power cable or a built-in power source (not illustrated).

The imaging-side controller 61 includes a CPU, a RAM, and the like, and is configured to comprehensively control operation of the components 62 to 65 of the imaging apparatus 60. The imaging-side controller 61 includes an oscillator (hereinafter, imaging side oscillator) 61a. The imaging side oscillator 61a can be configured by a crystal oscillator, a ceramic oscillator, or the like that generates a clock of a predetermined period when a power supply is turned on. The imaging-side controller 61 periodically generates clocking information using the clock generated by the imaging side oscillator 61a and has the function to do so. The format of the clocking information generated here is preferably the same as that of the clocking information generated by the irradiation apparatus 20. The sections 61 to 65 of the imaging apparatus 60 operate on the basis of the clock generated by the imaging-side oscillator 61a. Further, the imaging side oscillator 61a may selectively use a plurality of oscillators according to a purpose such as required accuracy.

The radiation detector 62 may be any conventionally known radiation detector including a substrate on which a plurality of pixels are two dimensionally arranged, each of the pixels including a radiation detection element that directly or indirectly generates charges corresponding to the dose of external radiation and a switch element that is provided between each radiation detection element and wiring and is switchable between an on-state in which conduction between the radiation detection element and the wiring is possible and an off-state in which conduction is not possible. That is, the imaging apparatus 60 may be a so-called indirect type that includes a scintillator and detects light emitted by the scintillator receiving radiation, or may be a so-called direct type that directly detects radiation without involving the scintillator or the like.

The readout section 63 may be configured to be capable of reading a signal value corresponding to the amount of charges accumulated in each of the plurality of radiation detection elements (generated by the radiation detection elements) and generating image data of a radiographic image based on each signal value, and a conventionally known readout section can be used.

The storage section 64 is composed of an HDD, a semiconductor memory, and the like, and stores various processing programs including various image processing programs, parameters and files required for executing the programs, and the like. The storage section 64 can store various kinds of data (for example, clocking information and the like) generated in the process of processing performed by the imaging-side controller 61. The storage section 64 stores synchronization compatible information indicating an apparatus compatible to the synchronization of the clocking information with the irradiation apparatus 20 or the irradiation apparatus 120, synchronization state information indicating a synchronization state of the clocking information with the irradiation apparatus 20 or the irradiation apparatus 120, an ID for identifying the irradiation apparatus (the irradiation apparatus 20 or the irradiation apparatus 120) that has synchronized the clocking information, synchronization time limit information, and the like.

The imaging-side IF section 65 is connectable to an external IF, and is configured to be able to transmit and receive various types of information (signal and data). Specifically, it can be composed of a connector or the like for inserting a communication cable (IFC).

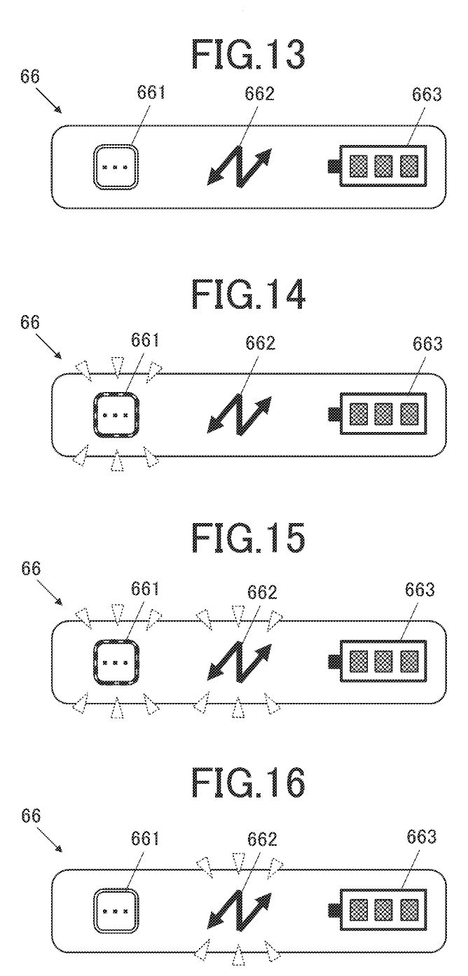

The display part 66 (display) is an indicator that includes a plurality of light emitting diodes (LEDs) and can display a state of the imaging apparatus 60 by light emission control of the LEDs. The display part 66 includes, for example, a synchronization state display part 661 (refer to FIG. 13 to FIG. 16) indicating a synchronization state with the irradiation apparatus 20 or the irradiation apparatus 120. The display part 66 also has a connection state display part 662 (see FIG. 13 to FIG. 16) indicating the state of connection to the irradiation apparatus 20 or the irradiation apparatus 120. The display part 66 also includes a remaining battery level display part 663 (see FIGS. 13 to 16) indicating the remaining battery level of the own apparatus 60. Note that display modes of the synchronization state display part 661 and the connection state display part 662 will be described later.

The operation part 67 includes a power switch (not shown) and various operation switches (not shown), and is configured to be operable by a user.

Note that when the imaging apparatus 60 is configured to receive power from a built-in power source, the built-in power source may be a lithium ion capacitor (LiC), a lithium ion battery (LiB), or any other power source. Since the lithium ion capacitor can be rapidly charged and does not ignite, the next imaging can be performed in a short time after the end of imaging (for example, mobile imaging). On the other hand, since the lithium ion battery is inexpensive and has a large capacity, it is possible to reduce the manufacturing cost of the imaging apparatus 60 and to reduce the number of times of charging. Any of the configurations is preferable for performing imaging a plurality of times.

The imaging-side controller 61 of the imaging apparatus 60 configured as described above operates as follows in accordance with a program stored in the storage section 64. For example, the imaging-side controller 61 has a function of switching the state of the imaging apparatus 60 to any one of an "initialization state", an "accumulation state", and a "reading and transmission state".

The "initialization state" is a state in which an ON voltage is applied to each switch element, and charges generated by the radiation detection element are not accumulated in each pixel (charges are discharged to the signal line). The "accumulation state" is a state in which an off-voltage is applied to each switch element and the charges generated by the radiation detection element can be accumulated in the pixel (the charges are not discharged to the signal line). The "read and transfer state" is a state where an on-voltage is applied to each switch element and the readout section 63 is driven so that a signal value based on the flowed charges can be read.

Note that repetition of the operation of setting the above-described initialization state before performing dynamic imaging consumes a large amount of power. Therefore, the imaging apparatus 60 may be configured to start the repetition of the operation of setting the initialization state before the dynamic imaging in response to a predetermined operation performed by the user, or may be configured to set a time corresponding to the workflow as wait and automatically start the operation after the wait elapses. In this way, it is possible to suppress power consumption in a series of workflows.

### 1-4. Medical Cart

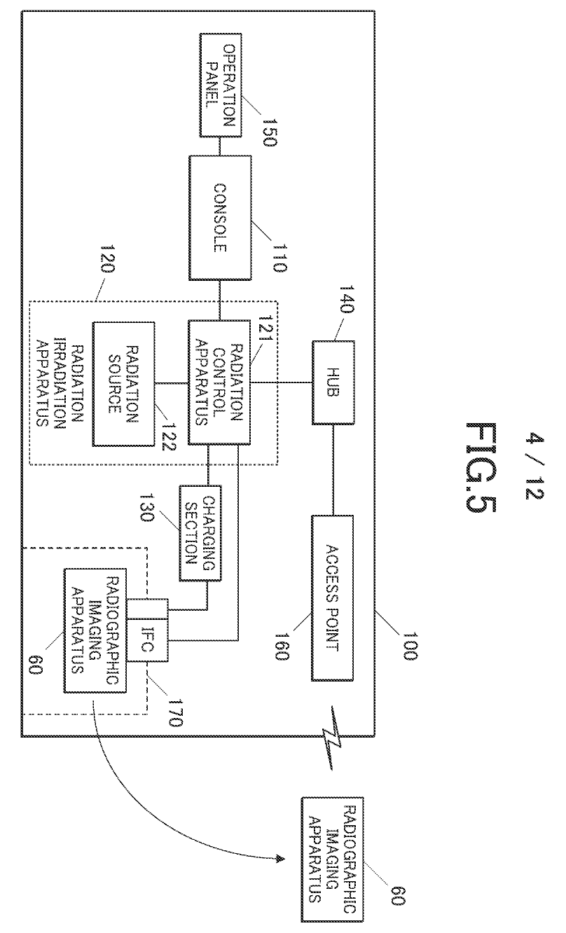

Next, a schematic configuration of the medical cart 100 included in the system 1 will be described with reference to FIG. 5. FIG. 5 is a block diagram showing a schematic configuration of the medical cart 100.

The medical cart 100 includes a console 110, an irradiation apparatus 120, a charging section 130, a hub 140, an operation panel 150, an access point 160, a storage section 170, and wheels (not shown), and is configured to be movable.

### 1-4-1. Console

Similarly to the console 10 (see FIGS. 1 and 2) described above, the console 110 can set imaging conditions (imaging mode (still image capturing or dynamic imaging), tube voltage, tube current-irradiation time or current-time product (mAs value), imaging area, imaging direction, and the like) in at least one of the control apparatus 121 and the imaging apparatus 60 on the basis of an imaging order acquired from another system such as a radiology department information system or a picture archiving and communication system or an operation performed on the operation panel 150 by the user (e.g., a radiologist). The console 110 can acquire image data of a radiographic image generated by the imaging apparatus 60, store the image data in itself, and transmit the image data to another apparatus (a PACS, a dynamic analysis apparatus, or the like).

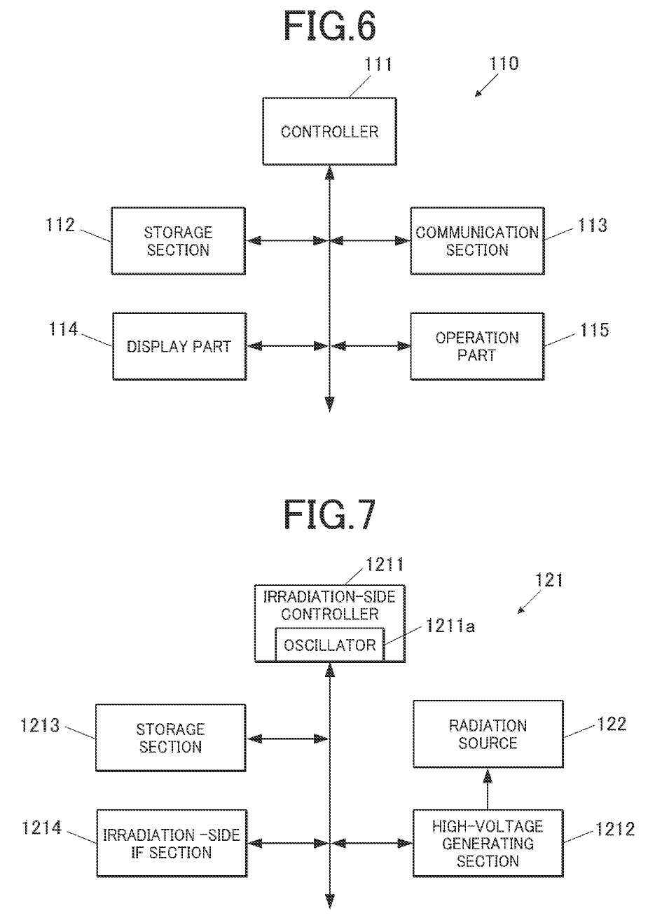

Next, a functional configuration of the console 110 will be described with reference to FIG. 6. FIG. 6 is a block diagram illustrating the functional configuration of the console 110.

As illustrated in FIG. 6, the console 110 includes a controller 111 (hardware processor), a storage section 112, a communication section 113, a display part 114, and an operation part 115. The sections 111 to 115 of the console 110 are electrically connected to each other by a bus or the like.

The controller 111 is formed with a CPU, a RAM, and the like, and performs centralized control of operation of sections of the console 110. The controller 111 executes synchronization processing for synchronizing signals indicating timings of radiation irradiation between the imaging apparatus 60 and the irradiation apparatus 120. In other words, the controller 111 executes synchronization processing for synchronizing the timing of radiographic imaging by the imaging apparatus 60 and the timing of radiation irradiation by the irradiation apparatus 120. The controller 111 also displays the synchronization state of the imaging apparatus 60 on the display part 114.

The storage section 112 includes a nonvolatile memory and a hard disk, and stores various programs to be executed by the CPU, parameters necessary for executing the programs, and the like. The storage section 112 is also capable of storing image data of a radiographic image acquired from another apparatus (such as the imaging apparatus 60). The storage section 112 also stores inspection order information transmitted from the RIS or the like. In addition, the storage section 112 stores each set of the irradiation apparatus 120 and the imaging apparatus 60 in which the clocking information is synchronized and associated with each other using an ID for identifying the set.

The communication section 113 is constituted by a communication module or the like. The communication section 113 transmits and receives various signals and various data to and from other apparatuses (the irradiation apparatus 120, the imaging apparatus 60, and the like) connected in a wired or wireless manner via a communication network.

The display part 114 includes, for example, an LCD and a CRT. The display part 114 displays a radiographic image or the like corresponding to an image signal received from the controller 111.

The operation part 115 includes a keyboard (e.g., cursor keys, number input keys, and various function keys), a pointing device (e.g., a mouse), and a touch screen stacked on the surface of the display part 114. The operation part 115 outputs a control signal corresponding to an operation performed by a user to the controller 111.

### 1-4-2. radiation irradiation apparatus

Similarly to the above-described irradiation apparatus 20 (see FIG. 1), the irradiation apparatus 120 generates radiation (e.g., X-rays) and irradiates the subject and the imaging apparatus 60 arranged behind the subject with the radiation, and includes a control apparatus 121 and a radiation source 122.

Next, a functional configuration of the control apparatus 121 included in the irradiation apparatus 120 will be described with reference to FIG. 7. FIG. 7 is a block diagram showing a functional configuration of the control apparatus 121.

As shown in FIG. 7, the control apparatus 121 includes an irradiation-side controller 1211, a high-voltage generating section 1212, a storage section 1213, and an irradiation-side IF section 1214. The respective sections 1211 to 1214 of the control apparatus 121 can be supplied with electric power by a power supply cable or a built-in power supply (not shown).

The irradiation-side controller 1211 includes a CPU, a RAM, and the like, and is configured to comprehensively control the operation of the components 1212 to 1214 of the control apparatus 121. The irradiation-side controller 1211 includes an irradiation-side oscillator 1211a. The irradiation side oscillator 1211a can be configured by a crystal oscillator, a ceramic oscillator, or the like that generates a clock of a predetermined cycle when the power is turned on. The irradiation-side controller 1211 periodically generates clocking information using the clock generated by the irradiation-side oscillator 1211a and has the function to do so. The clocking information generated here includes, for example, a timing signal and time information. The timing signal refers to a pulsed signal or the like that is output every time one or a plurality of clocks are generated. The time information indicates a count value or the like for counting up the timing signal. In addition, the respective sections 1211 to 1214 of the control apparatus 121 are operated based on the clock generated by the irradiation side oscillator 1211a. In addition, as the irradiation side oscillator 1211a, a plurality of oscillators may be used depending on the purpose such as the required accuracy.

The high-voltage generating section 1212 applies a voltage corresponding to a preset imaging condition to the radiation source 122 based on the reception of the timing signal from the Irradiation-side controller 1211. Here, the imaging conditions described above are, for example, conditions related to the subject such as an imaging mode (still image capturing or dynamic imaging), an imaging target site, and a physique, and conditions related to irradiation with radiation such as a tube voltage, a tube current, an irradiation time, a current-time product, and a frame rate. The imaging mode included in the imaging condition is, for example, information on an imaging method such as still image capturing and dynamic imaging. In the system 1 of the present embodiment, a photographing mode can be set in advance, and the high voltage generating section 1212 performs an operation suitable for the photographing mode in accordance with the setting of the photographing mode. Here, the dynamic imaging includes moving image capturing, but does not include capturing a still image while displaying a moving image. A series of images obtained by dynamic imaging is referred to as a dynamic image. The dynamic image includes a moving image, but does not include an image obtained by capturing a still image while displaying the moving image. When the imaging condition includes dynamic imaging, a pulsed voltage is repeatedly applied at predetermined intervals each time a timing signal is received. When a voltage is applied from the high-voltage generating section 1212, the radiation source 122 generates a dose of radiation corresponding to the applied voltage. Specifically, when a pulsed voltage is applied from the high-voltage generating section 1212, pulsed radiation is emitted.

The storage section 1213 is formed with an HDD, a semiconductor memory, or the like, and stores various processing programs, and parameters, files, and the like necessary for executing the processing programs. The storage section 1213 can store various kinds of data (for example, clocking information and the like) generated in the course of processing performed by the irradiation-side controller 1211. Further, the storage section 1213 stores an ID for identifying the imaging apparatus 60 with which the clocking information is synchronized. Further, the storage section 1213 stores synchronization deadline information.

The irradiation-side IF section 1214 is connectable to an external interface (IF) and is configured to be able to transmit and receive various kinds of information (signal and data). Specifically, it can be composed of a connector or the like for inserting a communication cable (IFC).

The irradiation-side controller 1211 of the irradiation apparatus 120 configured as described above operates as follows in accordance with a program stored in the storage section 1213. For example, the irradiation-side controller 1211 sets various imaging conditions (conditions relating to the subject such as an imaging mode (still image imaging or dynamic imaging), an imaging target site, and a subject, and conditions relating to radiation irradiation such as a tube voltage, a tube current, an irradiation time, a current-time product, and a frame rate). Furthermore, based on reception of the exposure permission notification from the imaging apparatus 60, the irradiation-side controller 1211 controls the high-voltage generating section 1212 to start exposure (emission of radiation). If the imaging condition includes dynamic imaging, exposure is performed at a cycle corresponding to the frame rate.

### 1-4-3. Others

The charging section 130 is for charging a built-in power source of the imaging apparatus 60. The charging section 130 may be charged by receiving power from an external power source (for example, an outlet of a hospital), may be charged by receiving power from a power source included in the medical cart 100, or may be charged by using a power source included in the medical cart 100. The hub 140 is, for example, a switching hub that relays between the irradiation apparatus 120 and the access point 160, and includes a plurality of ports.

The operation panel 150 includes an exposure switch (not illustrated) connected to a main body of the operation panel 150 by a wire. Based on the pressing of the exposure switch, the controller 111 of the console 110 transmits an imaging start signal to the control apparatus 121. In addition, based on the release of the exposure switch, the controller 111 of the console 110 transmits a signal to the control apparatus 121.

The access point 160 performs wireless communication with the imaging apparatus 60 using a wireless local area network (LAN) or the like. The storage section 170 is configured to be able to store the imaging apparatus 60. The storage section 170 includes an external IF that is connected to the imaging-side IF section 65 when the imaging apparatus 60 is housed. Specifically, a tip part of a communication cable (IFC) is attached to a place opposed to the imaging-side IF section 65 inside the storage section 170. The communication cable (IFC) connects the irradiation apparatus 120 and the imaging apparatus 60 to enable communication.

### 1-5. Others

The hub 40 is, for example, a switching hub that relays between the console 10 and the irradiation apparatus 20, between the irradiation apparatus 20 and the access point 50, and between the console 10 and the access point 50, and includes a plurality of ports. The access point 50 performs wireless communication with the imaging apparatus 60 by using a wireless LAN or the like. The communication cable (IFC) connects the irradiation apparatus 20 and the imaging apparatus 60 to enable communication.

The system 1 configured in such a manner can perform imaging of a subject by irradiating the subject (e.g., a subject located on the upright position imaging table 70) arranged between the irradiation apparatus 20 and the imaging apparatus 60 with radiation from the irradiation apparatus 20 in an imaging room. In an intensive care unit, the system 1 can image a subject by irradiating the subject disposed between the irradiation apparatus 120 and the imaging apparatus 60 with radiation from the irradiation apparatus 120 provided in the medical cart 100. Furthermore, the system 1 is capable of capturing a moving image (e.g., dynamic imaging). That is, based on one imaging operation (pressing of the exposure switch), the irradiation apparatus 20 or the irradiation apparatus 120 can continuously generate pulsed radiation having a preset time width a plurality of times at a constant interval, and the imaging apparatus 60 can generate a plurality of frame images constituting a moving image. The system 1 can also be configured to be communicable with other systems such as an RIS and a PACS, and an analysis apparatus.

### 2. Operation by Radiographic Imaging System

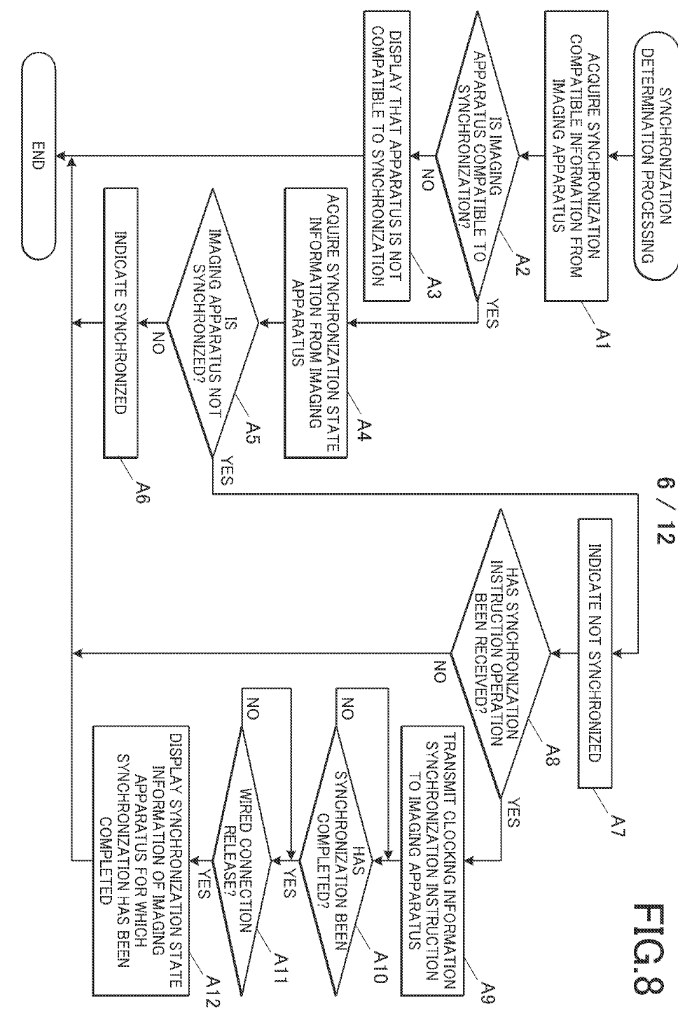

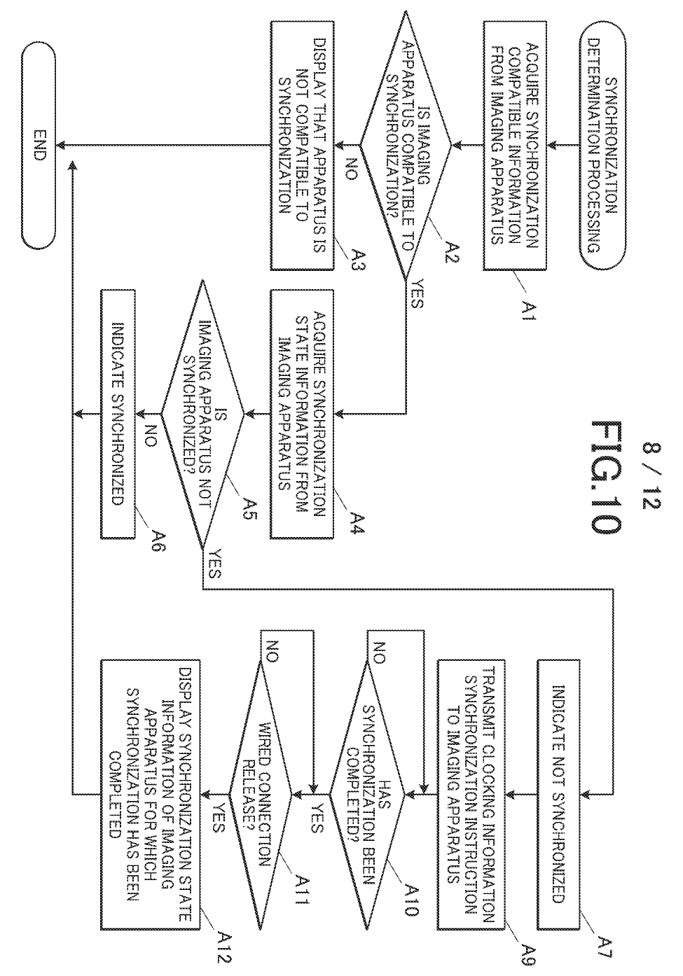

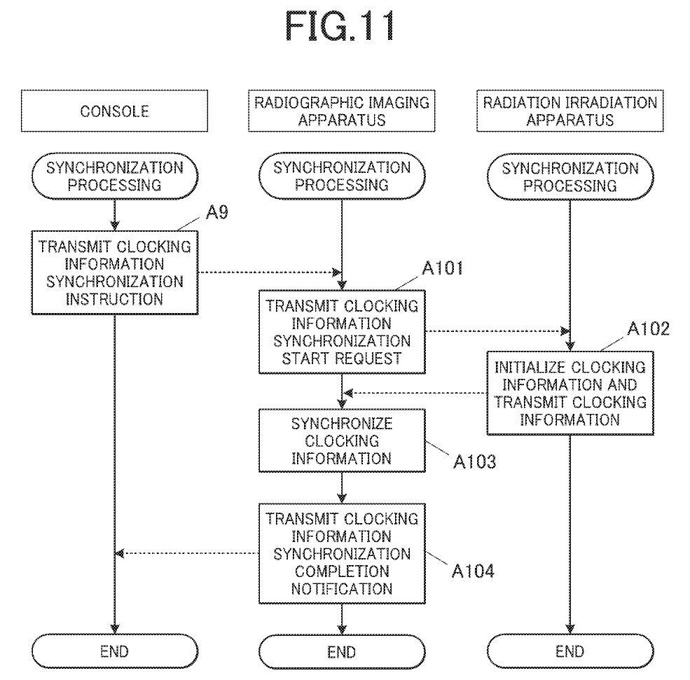

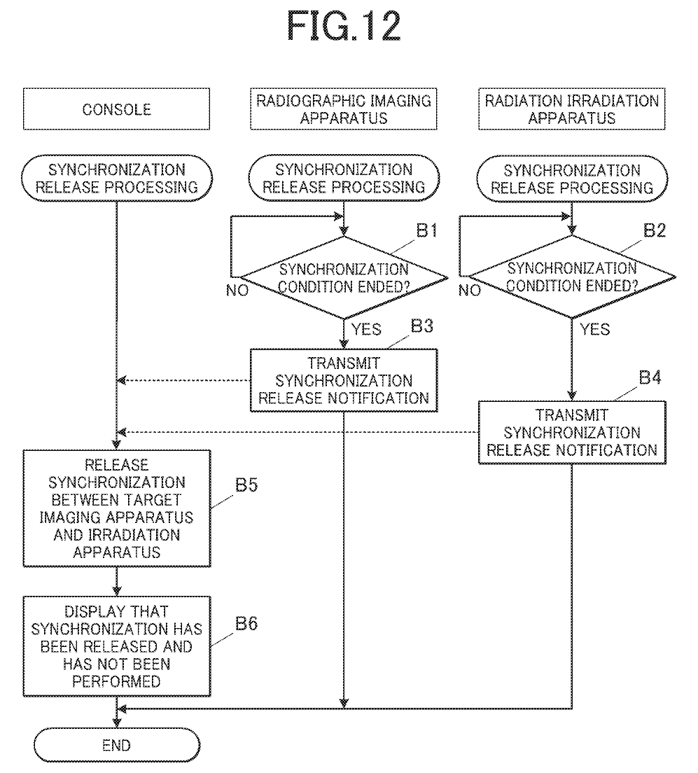

Next, operation performed by the system 1 will be described. In the system 1, when moving image capturing (dynamic imaging, fluoroscopy, or the like) is performed using the irradiation apparatus 20 (see FIG. 1) and the imaging apparatus 60 or the irradiation apparatus 120 (see FIG. 5) and the imaging apparatus 60 of which the clocking information is not synchronized, an abnormality may be generated. Therefore, in order to prevent moving image capturing by the irradiation apparatus 20 and the imaging apparatus 60 of which the clocking information is not synchronized, the controller 11 of the console 10 provided in the imaging management room (see FIG. 1) manages the association between the irradiation apparatus 20 and the imaging apparatus 60 involving the synchronization of the clocking information. In addition, in order to prevent capturing of a moving image between the irradiation apparatus 120 and the imaging apparatus 60 whose clocking information is not synchronized, the controller 111 of the console 110 provided in the medical cart 100 (see FIG. 5) manages the association between the irradiation apparatus 120 and the imaging apparatus 60 involving the synchronization of clocking information. Note that the management of the association between the irradiation apparatus 20 and the imaging apparatus 60 by the controller 11 and the management of the association between the irradiation apparatus 120 and the imaging apparatus 60 by the controller 111 are performed in the same manner. Here, the above-described processing includes synchronization determination processing (see FIG. 8), synchronization processing (see FIG. 11), synchronization release processing (see FIG. 12), and the like. Therefore, management of the association between the irradiation apparatus 20 and the imaging apparatus 60 by the controller 11 of the console 10 will be described below, and description of management of the association between the irradiation apparatus 120 and the imaging apparatus 60 by the controller 111 of the console 110 will be omitted.

Here, as illustrated in FIG. 1, when the imaging side IF section 65 of the imaging apparatus 60 and the irradiation side IF section 214 of the control apparatus 21 are wiredly connected to each other via the communication cable (IFC) provided in the upright position imaging table 70 or the recumbent position imaging table 80, the synchronization determination processing illustrated in FIG. 8 is started in the console 10. Further, when the wired connection is established, as shown in FIG. 13, the connection state display part 662 of the display part 66 of the imaging apparatus 60 is turned on. Here, when the wired connection is released (disconnected), the connection state display part 662 is displayed in a blinking state (see FIG. 15). The synchronization determination processing may be started when communication between the imaging side IF section 65 and the irradiation side IF section 214 is disconnected and reconnected during wired connection between the imaging side IF section 65 of the imaging apparatus 60 and the irradiation side IF section 214 of the control apparatus 21, when there is a synchronization instruction from the user via the operation part 15, or when a reset process is performed in communication between the irradiation apparatus 20 and the imaging apparatus 60.

As shown in FIG. 8, when the synchronization determination processing is started, first, the controller 11 of the console 10 acquires synchronization compatible information from the imaging apparatus 60 connected to the control apparatus 21 by wire (step A1). Subsequently, based on the synchronization compatible information acquired in step A1, the controller 11 determines whether the imaging apparatus 60 wiredly connected to the control apparatus 21 is a synchronization compatible apparatus (step A2).

In Step A2, when it is determined that the imaging apparatus 60 connected to the control apparatus 21 by wire is a apparatus not compatible to synchronization (Step A2; NO), the controller 11 displays that the imaging apparatus 60 is a apparatus not compatible to synchronization on the display part 14 (Step A3). Next, the controller 11 ends the present processing.

Furthermore, if it is determined in step A2 that the imaging apparatus 60 wiredly connected to the control apparatus 21 is a apparatus compatible with synchronization (YES in step A2), the controller 11 acquires synchronization state information from the imaging apparatus 60 (step A4). Subsequently, based on the synchronization state information acquired in step A4, the controller 11 determines whether or not the clocking information of the imaging apparatus 60 connected to the control apparatus 21 by wire is unsynchronized (step A5).

If, in step A5, it is determined that the imaging apparatus 60 wiredly connected to the control apparatus 21 has not been synchronized (step A5; NO), the controller 11 displays, on the display part 14, a message that the clocking information of the imaging apparatus 60 has been synchronized (step A12). Next, the controller 11 ends the present processing.

In Step A5, when it is determined that the imaging apparatus 60 connected to the control apparatus 21 by wire is not synchronized (Step A5; YES), the controller 11 displays on the display part 14 that the clocking information of the imaging apparatus 60 is not synchronized (Step A7).

Next, the controller 11 displays, on the display part 14, acceptance of an instruction as to whether or not to perform synchronization of the clocking information of the imaging apparatus 60 wiredly connected to the control apparatus 21, and determines whether or not an instruction operation for synchronization of the clocking information by the user has been accepted via the operation part 15 (step A8). Note that as illustrated in FIG. 9, in the synchronization determination processing, determination processing in step A8 may be executed first, and if in step A8, it is determined that the operation for giving an instruction to synchronize the clocking information has been accepted (step A8; YES), the processing in and after step A1 may be executed.

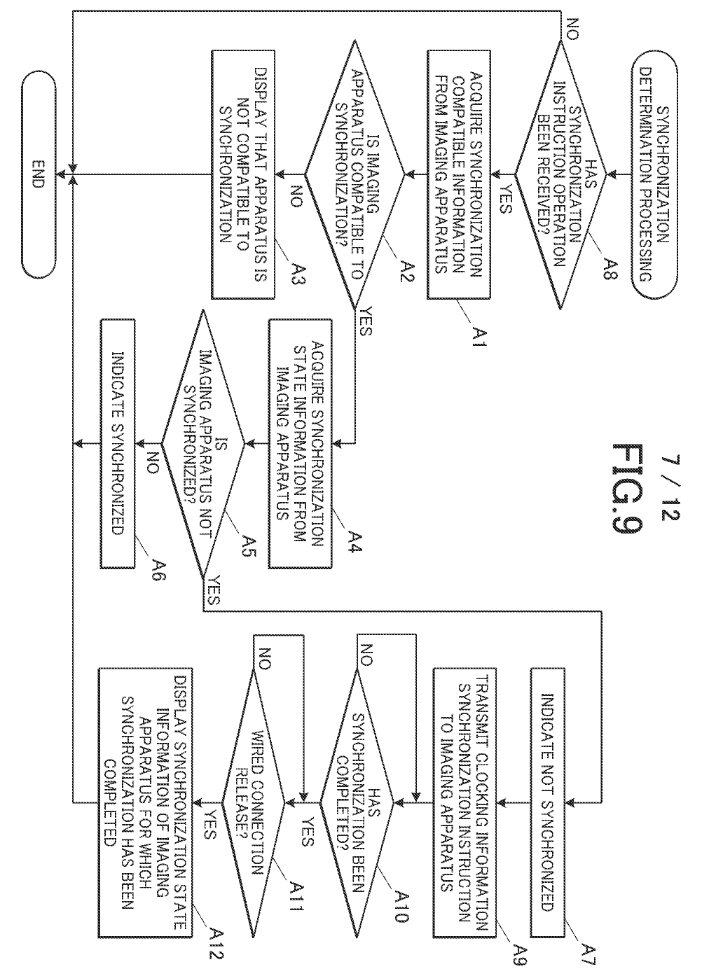

In step A8, in a case where it is determined that the instruction operation of the synchronization of the clocking information is not received (step A8; NO), the controller 11 ends the process. In addition, in Step A8, in a case where it is determined that the instruction operation of the synchronization of the clocking information is received (Step A8; YES), the controller 11 transmits the clocking information synchronization instruction to the imaging apparatus 60 which is connected to the control apparatus 21 in a wired manner (Step A9), and performs the synchronization of the clocking information in the irradiation apparatus 20 and the imaging apparatus 60. The synchronization processing of the clocking information described below may be automatically started when the irradiation side IF section 214 of the control apparatus 21 and the imaging side IF section 65 of the imaging apparatus 60 are connected by wire. In addition, as shown in FIG. 10, the controller 11 may not execute the determining processing of step A7 after executing the process of step A8, and may synchronize the clocking information in the irradiation apparatus 20 and the imaging apparatus 60 after executing the process of step A9.

FIG. 11 illustrates synchronization processing of clocking information in the irradiation apparatus 20 and the imaging apparatus 60.

As shown in FIG. 11, the imaging-side controller 61 that has received the clocking information synchronization instruction transmits a clocking information synchronization start request to the irradiation apparatus 20 (step A101). Next, the irradiation side controller 211 that has received the clocking information synchronization start request initializes the count value that is the time information, and transmits the generated clocking information to the imaging apparatus 60 (step A102). Next, the imaging-side controller 61 that has received the clocking information synchronizes its own clocking information at the time of reception of the clocking information based on the received clocking information (step A103). Specifically, based on the timing signal transmitted from the control apparatus 21, the imaging-side controller 61 generates a copy signal having the same rising timing as the timing signal, and synchronizes the count value. That is, the irradiation-side controller 211 and the imaging-side controller 61 generate the clocking information of the same count value at the same timing. Next, the imaging-side controller 61 transmits a clocking information synchronization completion notification to the console 10 (step A104).

Here, when the synchronization of the clocking information is completed, the imaging-side controller 61 causes the synchronization state display part 661 of the display part 66 to blink, as shown in FIG. 14. While the synchronization state display part 661 is blinking, the imaging apparatus 60 can capture a moving image by wirelessly connecting to the control apparatus 21 via the access point 50. When the wired connection with the control apparatus 21 is released (disconnected), the imaging-side controller 61 causes the connection state display part 662 of the display part 66 to blink, as shown in FIG. 15.

Returning to the synchronization determination processing (see FIG. 8), the controller 11 determines whether or not synchronization has been completed by determining whether or not a clocking information synchronization completion notification transmitted by the imaging apparatus 60 has been received (step A10).

In step A10, when it is determined that the synchronization is not completed (step A11; NO), the controller 11 shifts the processing to step A10. That is, the controller 11 waits until the clocking information synchronization completion notification is received. In addition, in Step A10, in a case where it is determined that the synchronization is completed (Step A10; YES), the controller 11 determines whether or not the wired connection between the imaging side IF section 65 of the imaging apparatus 60 and the irradiation side IF section 214 of the control apparatus 21 is released (Step A11).

In step A11, when it is determined that the wired connection is not released (step A11; NO), the controller 11 shifts the present process to step A11. That is, the controller 11 waits until the wired connection is released. If it is determined in step A11 that the wired connection has been released (YES in step A11), the controller 11 displays, on the display part 14, the synchronization state information of the imaging apparatus 60 for which synchronization has been completed (step A12). Next, the controller 11 ends the present processing.

FIG. 17 is a diagram illustrating an example of a display screen when state information on each imaging apparatus 60 before synchronization of the imaging apparatuses 60 on the panel ID"P002" is completed is displayed on the display part 14. FIG. 17 is a diagram illustrating an example of a display screen when the state information of each imaging apparatus 60 is displayed on the display part 14 after the synchronization of the imaging apparatus 60 on the panel ID"P002" is completed.

As shown in FIG. 17, the display of the battery remaining amount information 141 corresponding to the imaging apparatus 60 on the panel ID"P001" indicates that the battery remaining amount of the imaging apparatus 60 is "30%". Further, the display of the synchronization time limit information 142 corresponding to the imaging apparatus 60 in the panel ID"P001" indicates that the synchronization maintainable time of the imaging apparatus 60 is "remaining 45 minutes". In addition, the display of the synchronized information 143 corresponding to the imaging apparatus 60 on the panel ID"P001" indicates that the imaging apparatus 60 has been synchronized.

Further, as shown in FIG. 17, the display of the battery remaining amount information 141 corresponding to the imaging apparatus 60 on the panel ID"P002" indicates that the battery remaining amount of the imaging apparatus 60 is "30%". Here, in the display screen example illustrated in FIG. 17, the synchronization time limit information 142 and the synchronized information 143 are not displayed for the imaging apparatus 60 of the panel ID"P002". That is, in the display screen example illustrated in FIG. 17, the imaging apparatus 60 of the panel ID"P002" is not synchronized.

On the other hand, when the synchronization of the imaging apparatus 60 of the panel ID"P002" is completed and the wired connection with the irradiation-side IF section 214 of the control apparatus 21 is released, as shown in FIG. 18, the display of the synchronized information 143 corresponding to the imaging apparatus 60 of the panel ID"P002" indicates that the imaging apparatus 60 has been synchronized. At this time, the display of the synchronization time limit information 142 corresponding to the imaging apparatus 60 on the panel ID"P002" indicates that the synchronization maintainable time of the imaging apparatus 60 is "remaining 60 minutes". Further, as shown in FIG. 18, the display of the synchronized information 143 corresponding to the imaging apparatus 60 on the panel ID"P001" indicates that the imaging apparatus 60 has been synchronized. Further, the display of the synchronization time limit information 142 corresponding to the imaging apparatus 60 in the panel ID"P001" indicates that the synchronization maintainable time of the imaging apparatus 60 is "remaining 40 minutes". As described above, in the present embodiment, even after the synchronization of the imaging apparatus 60 for the panel ID"P002" is completed, the synchronization of the imaging apparatus 60 for the panel ID"P001" is maintained without being released.

Next, a case where the synchronization between the irradiation apparatus 20 and the imaging apparatus 60 is released will be described.

FIG. 12 shows a flowchart of the synchronization release processing executed in the console 10, the irradiation apparatus 20, and the imaging apparatus 60.

In the synchronization release processing, the imaging apparatus 60 imaging-side controller 61 determines whether or not the synchronization condition has ended (step B1). Here, the end of the synchronization condition refers to the expiry of a synchronization maintainable time (synchronization deadline), the connection to an irradiation apparatus (e.g., the irradiation apparatus 120) different from the associated irradiation apparatus 20 via a communication cable, the connection of the imaging apparatus 60 to a cradle (not illustrated), or the occurrence of a transition of the power state such as transition to power saving, power OFF, or a reduction in the remaining battery level. In step B1, when it is determined that the synchronization condition is not ended (step B1; NO), the imaging-side controller 61 shifts the present process to step B1.

Similarly, the irradiation-side controller 211 of the irradiation apparatus 20 determines whether the synchronization condition is over (step B2). Here, the termination of the synchronization condition is a case where the synchronization maintainable time (synchronization deadline) expires, or a transition of the power supply state such as transition to power saving, power OFF, or a decrease in the remaining battery level occurs. If it is determined in step B2 that the synchronization condition has not ended (step B2; NO), the irradiation-side controller 211 proceeds to step B2.

In the imaging apparatus 60, in a case where it is determined that the synchronization condition is ended (step B1; YES), the imaging-side controller 61 transmits a synchronization release notification indicating that the synchronization of the clocking information is released to the console 10 (step B3). When the synchronization condition is ended, the imaging-side controller 61 ends the blinking display of the synchronization state display part 661 as shown in FIG. 16. Similarly, in the irradiation apparatus 20, if it is determined that the synchronization condition has ended (step B2; YES), the irradiation-side controller 211 transmits, to the console 10, a synchronization release notification indicating that the synchronization of the clocking information has been released (step B4).

Next, the controller 11 of the console 10 that has received the synchronization release notification from the imaging apparatus 60 or the irradiation apparatus 20 stores the pair of the irradiation apparatus 20 and the imaging apparatus 60 for which the synchronization is released in the storage section 12 as unsynchronized, and the synchronization release is executed in the unsynchronized pair of the irradiation apparatus 20 and the imaging apparatus 60, and the unsynchronization is displayed on the display part 14 (step B5). To be more specific, when the synchronization between the imaging apparatus 60 with the panel identifier "P002" and the irradiation apparatus 20 is released, the synchronization time limit information 142 and the synchronized information 143 (see FIG. 18) corresponding to the imaging apparatus 60 are hidden as shown in FIG. 17, thereby indicating that the imaging apparatus 60 with the panel identifier "P002" and the irradiation apparatus 20 are not synchronized. Next, the controller 11 ends the present processing.

### 3. Effects

As described above, the control apparatus (the console 10 or the console 110) included in the system 1 according to the present embodiment includes a controller (the controller 11 or the controller 111) that controls radiographic imaging by the imaging apparatus 60 with the panel identifier "P002" that has performed the synchronization processing earlier than the imaging apparatus 60 with the panel identifier "P001", for example, based on the synchronization state of the imaging apparatus 60. To be specific, after the synchronization of the imaging apparatus 60 having the panel ID "P002" is completed, the controller (the controller 11 or the controller 111) maintains the synchronization of the imaging apparatus 60 having the panel ID "P001" on which the synchronization processing has been performed earlier than the imaging apparatus 60.

Therefore, according to the system 1, since a plurality of imaging apparatuses 60 capable of capturing a moving image (dynamic imaging, fluoroscopic imaging) by the above-described wireless connection, that is, the synchronized imaging apparatuses 60 can be on standby, the usability of the imaging apparatuses 60 can be improved.

In addition, the control apparatus (the console 10 or the console 110) includes a display part (the display part 14 or the display part 114) that displays the synchronization states of the plurality of imaging apparatus 60 with the panel IDs "P001" and "P002".

Therefore, according to the system 1, since the console 10 or the console 110 can grasp the synchronization state of each imaging apparatus 60, it is possible to further improve the usability of the imaging apparatus 60.

Each of the imaging apparatus 60 for the panel ID"P001" and the panel ID"P002" includes the display part 66 for displaying the state of synchronization. Therefore, according to the system 1, since the synchronization state of the own apparatus 60 can be grasped by each imaging apparatus 60, it is possible to further improve usability of the imaging apparatus 60.

In addition, since the irradiation apparatus 120 and the control apparatus (console 110) are mounted on the medical cart 100, video imaging can be performed by wireless connection even in a place other than an imaging room (for example, an intensive care unit).

### 4. Other

Note that the present disclosure is not limited to the above-described embodiment and the like, and it goes without saying that changes can be made as appropriate without departing from the spirit of the present disclosure.

For example, in the embodiment described above, after the synchronization of the imaging apparatus 60 for the panel ID"P002" is completed, the synchronization of the imaging apparatus 60 for the panel ID"P001" for which synchronization processing has been performed earlier than that for the imaging apparatus 60 for the panel jam may be released.

Furthermore, although the system 1 is configured to include the irradiation apparatus 20 and the irradiation apparatus 120 in the embodiment described above, this configuration is merely an example. For example, the system 1 may be configured to be used only in an imaging room or the like without the irradiation apparatus 120, that is, without the medical cart 100. In addition, the system 1 may not include the irradiation apparatus 20, that is, may include the medical cart 100 and the plurality of imaging apparatus 60.

Furthermore, in the above embodiment, as illustrated in FIGS. 17 and 18, when the synchronized information 143 is displayed on the display part 14 of the console 10, information indicating with which irradiation apparatus the synchronization has been established may be displayed in association with the corresponding imaging apparatus 60. The information indicating with which irradiation apparatus the synchronization is established includes, for example, a diagram simulating the irradiation apparatus.

In addition, in the above-described embodiment, for example, even while video imaging (dynamic imaging or fluoroscopic imaging) is performed by wired connection in the upright position imaging table 70 of the imaging room, synchronization processing may be executed in the recumbent position imaging table 80.

In addition, in the above-described embodiment, a predetermined mark may be attached to the housing or the like of the modality so that the user can grasp the modality capable of executing the synchronization processing at a glance. In the present embodiment, modalities that can execute the synchronization processing include the upright position imaging table 70 and the recumbent position imaging table 80 provided in the imaging room, and the medical cart 100 used in an intensive care unit or the like.

Further, in the above embodiment, when the synchronized imaging apparatus 60 is connected to the cradle (not shown), the synchronization is released, but the synchronization may be maintained.

Further, in the above-described embodiment, even in a case where the imaging side IF section 65 of the imaging apparatus 60 and the irradiation side IF section 214 of the control apparatus 21 are connected in a wired manner via the communication cable (IFC) provided in the upright position imaging table 70 or the recumbent position imaging table 80, it is possible to perform moving image imaging by wireless connection. Furthermore, in such a case, the priority of the video imaging by the wired connection and the video imaging by the wireless connection may be set based on a user operation. To enable synchronization processing for moving image photographing by wireless connection to be executed even during moving image photographing by wired connection when giving priority to the moving image photographing by the wired connection. However, the synchronization processing is executed at the timing of image transfer after the end of moving image shooting in order to prevent unnecessary noise from entering during moving image shooting by wired connection. On the other hand, when moving image capturing by wireless connection is prioritized, it is preferable to frequently execute synchronization processing in order to avoid noise via a communication cable. Furthermore, since the medical cart 100 has a limited power supply, whether the video imaging is performed by wireless connection or wired connection may be appropriately adjusted depending on the situation. Further, even in a case where priority is given to the moving image photographing by the wireless connection, when the wireless connection is disconnected and the wired connection can be confirmed, the moving image photographing by the wired connection is performed.

Furthermore, although the console 10 or the console 110 is described as corresponding to the control apparatus according to the present disclosure in the above embodiment, the radiation control apparatus 21 or the radiation control apparatus 121 may correspond to the control apparatus according to the present disclosure. In such a case, the irradiation-side controller 211 or the irradiation-side controller 1211 corresponds to the control apparatus included in the above-described controller.

According to the present embodiment, the usability of the radiographic imaging apparatus can be improved.

In addition, the detailed configuration and the detailed operation of each apparatus configuring the system 1 can also be appropriately modified without departing from the spirit and scope of the present disclosure.

Although embodiments of the present disclosure have been described and illustrated in detail, the disclosed embodiments are made for purposes of illustration and example only and not limitation. The scope of the present disclosure should be interpreted by terms of the appended claims.

What is claimed is:

1. A radiographic imaging system comprising:
a first radiographic imaging apparatus and a second radiographic imaging apparatus capable of generating moving image data;
a radiation irradiation apparatus that irradiates the first radiographic imaging apparatus or the second radiographic imaging apparatus with radiation; and
a control apparatus that executes synchronization processing of synchronizing a timing of radiographic imaging by the first radiographic imaging apparatus or the second radiographic imaging apparatus with a timing of radiation irradiation by the radiation irradiation apparatus,
wherein the control apparatus includes
a hardware processor that controls, based on a state of the synchronizing of the first radiographic imaging apparatus, radiographic imaging by the second radiographic imaging apparatus for which the synchronization processing has been performed earlier than the first radiographic imaging apparatus.

2. The radiographic imaging system according to claim 1, wherein the hardware processor releases the synchronizing of the second radiographic imaging apparatus after completion of the synchronizing of the first radiographic imaging apparatus.

3. The radiographic imaging system according to claim 1, wherein
the hardware processor maintains the synchronizing of the second radiographic imaging apparatus after completion of the synchronizing of the first radiographic imaging apparatus.

4. The radiographic imaging system according to claim 1, wherein
the control apparatus includes a display to display a state of the synchronizing of the first radiographic imaging apparatus and the second radiographic imaging apparatus.

5. The radiographic imaging system according to claim 1, wherein
the first radiographic imaging apparatus and the second radiographic imaging apparatus include a display to display a state of the synchronizing.

6. The radiographic imaging system according to claim 1, wherein
the radiation irradiation apparatus and the control apparatus are mounted on a medical cart.

7. The radiographic imaging system according to claim 1, wherein
each of the first radiographic imaging apparatus and the second radiographic imaging apparatus is capable of performing wired imaging for performing radiographic imaging in a state of being wiredly connected to the radiation irradiation apparatus and wireless imaging for performing radiographic imaging in a state of being wirelessly connected to the radiation irradiation apparatus, and
the hardware processor prioritizes the wired imaging over the wireless imaging in a case where the first radiographic imaging apparatus or the second radiographic imaging apparatus is in a state of being wiredly connected to the radiation irradiation apparatus.

8. The radiographic imaging system according to claim 1, wherein
each of the first radiographic imaging apparatus and the second radiographic imaging apparatus is capable of performing wired imaging for performing radiographic imaging in a state of being wiredly connected to the radiation irradiation apparatus and wireless imaging for performing radiographic imaging in a state of being wirelessly connected to the radiation irradiation apparatus, and
the hardware processor prioritizes the wireless imaging over the wired imaging in a case where the first radiographic imaging apparatus or the second radiographic imaging apparatus is in a state of being wiredly connected to the radiation irradiation apparatus.

9. A control apparatus that executes synchronization processing for synchronizing a timing of radiographic imaging by a first radiographic imaging apparatus or a second radiographic imaging apparatus capable of generating moving image data with a timing of radiation irradiation by a radiation irradiation apparatus that irradiates the first radiographic imaging apparatus or the second radiographic imaging apparatus with radiation, the control apparatus comprising
a hardware processor that controls, based on a state of the synchronizing of the first radiographic imaging apparatus, radiographic imaging by the second radiographic imaging apparatus for which the synchronization processing has been performed earlier than the first radiographic imaging apparatus.
